(19) United States
(12) Patent Application Publication
(10) Pub. No.: US 2026/0225354 A1
(43) Pub. Date: Aug. 6, 2026

(54) RELEASE LINER FREE LAMINATABLE ION-CONDUCTING MULTILAYER POLYMER MATERIAL

(71) Applicant: Miru Smart Technologies Corp., Vancouver (CA)

(72) Inventors: Faezeh Habib Zadeh, Vancouver (CA); Curtis Paul Berlinguette, Vancouver (CA); Hayley Phoeba Delima, Vancouver (CA); John Santos, Vancouver (CA)

(73) Assignee: Miru Smart Technologies Corp., Vancouver, BC (CA)

(21) Appl. No.: 19/150,893

(22) PCT Filed: Feb. 2, 2024
(86) PCT No.: PCT/CA2024/050130

§ 371 Date: Jul. 24, 2025

Related U.S. Application Data
(60) Provisional application No. 63/443,125, filed on Feb. 3, 2023.

(51) Int. Cl. B32B 17/10; B32B 27/08; B32B 27/22; B32B 27/24; B32B 27/30; B32B 27/40

(52) U.S. Cl. CPC B32B 17/10761; B32B 17/10036; B32B 17/10513; B32B 17/10605; B32B 27/08; B32B 27/22; B32B 27/24; B32B 27/306; B32B 27/40; B32B 2307/7376; B32B 2457/10; B32B 2457/16; B32B 2457/18

(57) ABSTRACT

A release liner free, laminatable multilayer polymer stack for incorporation into electrochemical devices. The multi-layer stack comprises an ion-conducting layer and one or more substantially non-ion-conducting protective layers layered on the ion-conducting layer. Upon processing, the one or more protective layers become ion-conducting such that the entire multi-layer stack is ion-conducting.

### REFERENCE TO RELATED APPLICATIONS

This application claims priority from, and for the purposes of the United States the benefit under 35 USC 119 in relation to, U.S. patent application No. 63/443,125 filed on 3 Feb. 2023, which is hereby incorporated herein by reference.

### FIELD OF INVENTION

The present disclosure relates in general to a multilayer polymer material comprising a release liner free, laminatable multilayer polymer stack that becomes fully ion-conducting upon processing. This multilayer polymer stack can be incorporated as the electrolyte layer of an electrochemical device, such as an electrochromic window, lithium ion battery or capacitor.

### BACKGROUND

Electrochemical devices, including but not limited to batteries, electrochromic windows, sensors, capacitors and supercapacitors, incorporate an ion-conducting interlayer, or electrolyte, which permits charge transport between opposing electrodes. This ion-conducting interlayer should also be electrically insulating.

For large format electrochemical devices, it is desirable for ion-conducting interlayers to exhibit uniform adhesion to the opposing electrodes and mechanical stability. In some applications, such as electrochromic windows, it is also desirable that the electrolyte exhibits optical transparency, clarity and resistance to degradation by ultraviolet (“UV”) light and temperature variation.

Liquid electrolytes may be employed as such an ion-conducting interlayer as liquid electrolytes are known to provide high ionic conductivity in these devices. However, use of liquid electrolytes may be undesirable where damage to the device would result in safety concerns due to leakage of the liquid electrolyte. Further, liquid electrolytes may not be suitable for large format devices due to the challenges associated with hydrostatic pressure.

Incorporation of polymers in an ion-conducting interlayer to gellate or solidify a liquid electrolyte can provide the physical properties desired to overcome the safety and hydrostatic pressure challenges.

Polymer-based ion-conducting interlayers may provide high mechanical strength and greater fabrication flexibility compared to traditional liquid electrolytes, as well as better physical separation of the opposing electrodes.

Oftentimes, these polymer-based ion-conducting interlayers are composed of polymer resins containing additives to make the polymer resins ion-conducting. Such additives generally include plasticizers, solvents, salts and stabilizers.

These polymer-based ion-conducting interlayers often comprise materials sensitive to humidity, dust and other air contaminants. It is therefore desirable for manufacturing and transport of these materials to be performed in clean environments, and, if humidity sensitive, in a dry environment to avoid degradation. However, this can be undesirably cumbersome and/or costly. Handling and transportation of the polymer-based ion-conducting interlayer materials outside a clean environment can be made possible by protecting the polymer-based ion-conducting interlayer materials between a pair of non-reactive release liner films.

Such release liners films may comprise plastic or paper based films or sheets that have an anti-adhesive surface. Release liners may be used to prevent a sticky or adhesive surface from prematurely adhering. A release liner can also be called a release paper. The release liner films protect the reactive components of the ion-conducting polymer from the environment during shipping and storage thereby reducing the complexity and cost of shipping and storage. Further, this allows large sheets or rolls of ionically conductive polymer protected by release liner films to be manufactured at a dedicated film production facility and shipped to an electrochemical device manufacturing facility. Providing the film in this format also permits the film to be cut to size as needed.

Unfortunately, these release liner films are disposed of after use thereby generating an undesirable waste stream and increasing costs, raw material usage, and energy usage.

Since many ion-conductive polymer interlayers are very sticky, it can be difficult to later remove a release liner without damaging the ion-conducting material.

There is therefore a need for an alternative solution to replace or reduce the use of release liner films.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

One aspect of the invention provides release liner free, laminatable multilayer polymer stack for incorporation into electrochemical devices. The multilayer stack comprises an ion-conducting layer and one or more substantially non-ion-conducting protective layers layered on the ion-conducting layer. Upon processing, the one or more protective layers become ion-conducting such that the entire multi-layer stack is ion-conducting.

In some embodiments, the one or more protective layers of the release liner free, laminatable multilayer polymer stack exhibit ion-conductivity of less than 1.0×10−8 S/cm.

In some embodiments, the one or more protective layers of the release liner free, laminatable multilayer polymer stack comprise a first protective layer and a second protective layer and the ion-conducting layer is sandwiched between the first protective layer and the second protective layer.

In some embodiments, upon processing, the one or more protective layers of the release liner free, laminatable multilayer polymer stack exhibit ion-conductivity of greater than 1.0×10−7 S/cm.

In some embodiments, processing the release liner free, laminatable multilayer polymer stack comprises the application of heat. In some embodiments, processing the release liner free, laminatable multilayer polymer stack comprises the application of pressure. In some embodiments, processing the release liner free, laminatable multilayer polymer stack comprises the application of heat at a temperature of between approximately 80° C. and 100° C..

In some embodiments, the ion-conducting layer of the release liner free, laminatable multilayer polymer stack comprises a polymer base material, a plasticizer, a solvent and a salt.

In some embodiments, the ion-conducting layer of the release liner free, laminatable multilayer polymer stack comprises between approximately 15% and 45 (by weight) of a polymer base material, between approximately 45% and 75% (by weight) of a plasticizer and between approximately 10% and 20% (by weight) of a salt.

In some embodiments, the polymer base material of the release liner free, laminatable multilayer polymer stack comprises a thermoset polymer. In some embodiments, the polymer base material of the release liner free, laminatable multilayer polymer stack comprises a thermoplastic polymer. In some embodiments, the polymer base material of the release liner free, laminatable multilayer polymer stack comprises polyvinyl butyral (PVB). In some embodiments, the polymer base material of the release liner free, laminatable multilayer polymer stack comprises one or more of polyurethane, polyvinyl chloride, and ethyl vinyl acetate based polymer.

In some embodiments the salt of the release liner free, laminatable multilayer polymer stack comprises a lithium salt. In some embodiments, the salt of the release liner free, laminatable multilayer polymer stack comprises one or more of lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato)borate and lithium difluoro(oxalato)borate.

In some embodiments, the plasticizer of the release liner free, laminatable multilayer polymer stack comprises one or more of propylene carbonate, ethylene carbonate, tetraglyme, triethylene glycol bis(2-ethylhexanoate), dimethyl glutarate, dimethyl 2-methylglutarate, bis(2-butoxyethyl) adipate, dimethyl adipate, diethyl carbonate, sulfolane, tetraglyme, y-butyrolactone, triethylene glycol bis(2-ethylhexanoate), diethylene glycol butyl ether, diethylene glycol dibutyl ether, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone).

In some embodiments, the ion-conducting layer of the release liner free, laminatable multilayer polymer stack further comprises one or more additives selected from fillers, ultraviolet stabilizers, heat stabilizer, adhesion improvers, antioxidants, radical scavengers, cross linkers, impact modifiers, ultraviolet light absorbers, ionic liquids, pigments, dyes, infrared light absorbers or blockers, surfactants, chelating agents, and impact modifiers.

In some embodiments, wherein a thickness of the ion-conducting layer of the release liner free, laminatable multilayer polymer stack is between approximately 10 μm and 300 μm. In some embodiments, a thickness of the ion-conducting layer of the release liner free, laminatable multilayer polymer stack is between approximately 10 μm and 100 μm.

In some embodiments, each of the one or more protective layers of the release liner free, laminatable multilayer polymer stack comprises a protective layer polymer base material. In some embodiments, the protective layer polymer base material of the release liner free, laminatable multilayer polymer stack is different from a polymer base material of the ion-conducting layer.

In some embodiments, the protective layer polymer base material of the release liner free, laminatable multilayer polymer stack comprises a thermoset polymer. In some embodiments, the protective layer polymer base material of the release liner free, laminatable multilayer polymer stack comprises a thermoplastic polymer. In some embodiments, wherein the protective layer polymer base material of the release liner free, laminatable multilayer polymer stack comprises polyvinyl butyral (PVB). In some embodiments, the protective layer polymer base material of the release liner free, laminatable multilayer polymer stack comprises one or more of polyurethane, polyvinyl chloride, and ethyl vinyl acetate based polymer.

In some embodiments, each of the one or more protective layers of the release liner free, laminatable multilayer polymer stack comprises one or more protective layer additives selected from fillers, ultraviolet stabilizers, heat stabilizer, adhesion improvers, antioxidants, radical scavengers, cross linkers, impact modifiers, ultraviolet light absorbers, ionic liquids, pigments, dyes, infrared light absorbers or blockers, surfactants, chelating agents, and impact modifiers.

In some embodiments, a concentration of ultraviolet light stabilizer in the ion-conducting layer of the release liner free, laminatable multilayer polymer stack is less than an amount of ultraviolet light stabilizer in at least one of the one or more protective layers.

In some embodiments, a degree of cross-linking in the ion-conducting layer of the release liner free, laminatable multilayer polymer stack is different than a degree of cross-linking in at least one of the one or more protective layers.

In some embodiments, a density of the ion-conducting layer of the release liner free, laminatable multilayer polymer stack is different than a density of at least one of the one or more protective layers.

In some embodiments, a hardness of the ion-conducting layer of the release liner free, laminatable multilayer polymer stack is different than a hardness of at least one of the one or more protective layers.

In some embodiments, at least one of the one or more protective layers of the release liner free, laminatable multilayer polymer stack comprises a pigment or dye such that the at least one of the one or more protective layers is tinted relative to the ion-conducting layer.

In some embodiments, a thickness of each of the one or more protective layers of the release liner free, laminatable multilayer polymer stack is between approximately 25 μm and 350 μm. In some embodiments, a thickness of each of the one or more protective layers of the release liner free, laminatable multilayer polymer stack is between approximately 25 μm and 50 μm. In some embodiments, a thickness of a first protective layer of the release liner free, laminatable multilayer polymer stack of the one or more protective layers is different than a thickness of a second protective layer of the one or more protective layers.

In some embodiments, a broad surface of at least one of the one or more protective layers of the release liner free, laminatable multilayer polymer stack is textured. In some embodiments, a broad surface of at least one of the one or more protective layers has a surface texture variance of between 5.0 μm and 1.0 mm.

Another aspect of the invention provides an electrochemical device comprising a multilayer polymer film located between a first electrically conductive substrate containing an anodic material and a second electrically conductive substrate containing a cathodic material wherein the multilayer polymer film comprises the release liner free, laminatable multilayer polymer stack described herein.

In some embodiments, the electrochemical device is a battery, sensor, electrochromic device, fuel cell, capacitor or supercapacitor, membrane reactor, or electrolyzer.

Another aspect of the invention provides a method of fabricating an electrochemical device. The method may comprise forming an assembly by layering a multilayer polymer film between a first electrically conductive substrate containing an anodic material and a second electrically conductive substrate containing a cathodic material.

The method may also comprise applying heat and pressure to laminate the assembly thereby making the entire multilayer polymer film ion-conducting.

The method may also comprise the multilayer polymer film which may comprise the release liner free, laminatable multilayer polymer stack having the features described herein.

The method may also comprise, coupling one or more busbars to the first and second conductive materials and applying an electric bias between the busbars to cause a movement of ions through the device.

The method may also comprise applying an edge sealant to protect the ion-conductive material.

Another aspect of the invention provides a release liner free, laminatable multilayer polymer stack for incorporation into electrochemical devices. The stack may comprise a first non-ion-conducting polymer layer, an ion-conducting polymer layer, a second non-ion-conducting polymer layer. Said ion-conducting polymer layer may be sandwiched between said first and second non-ion-conducting polymer layers. Upon processing, the entire release liner free, laminatable multilayer polymer stack transitions to an ion-conducting polymer interlayer.

In some embodiments, the processing step comprises a lamination process involving heat and optionally also pressure.

In some embodiments the initial ion-conducting polymer layer the release liner free, laminatable multilayer polymer stack may comprise about 15 (wt %) to about 45 (wt %) polymer resin, about 45 (wt %) to about 75 (wt %) plasticizer component, and about 10 (wt %) to about 20 (wt %) lithium salt.

In some embodiments, the non-ion-conducting layers the release liner free, laminatable multilayer polymer stack may comprise about 90-100% polymer resin.

In some embodiments, the same polymer resin is utilized in each layer in the release liner free, laminatable multilayer polymer stack. In some embodiments, the polymer resin utilized in the non-ion-conducting layers differs from the polymer resin utilized in the initial ion-conducting layer within the release liner free, laminatable multilayer polymer stack. In some embodiments, the polymer resin utilized in the non-ion-conducting layers of the release liner free, laminatable multilayer polymer stack differ in composition from each other.

In some embodiments, the polymer layers of the release liner free, laminatable multilayer polymer are thermoplastics or thermosets.

In some embodiments, the polymer layers of the release liner free, laminatable multilayer polymer may comprise one or more of poly(vinyl butyral), polyurethane, poly(ethylene oxide), poly(ethylene vinyl acetate) and combinations thereof. These polymers can be utilized alone, or in combination with other polymers.

In some embodiments, the non-ion-conducting layers of the release liner free, laminatable multilayer polymer may comprise a polyvinyl butyral resin.

In some embodiments, the initial ion-conducting layer of the release liner free, laminatable multilayer polymer may comprise a polyvinyl butyral resin.

In some embodiments, of the release liner free, laminatable multilayer polymer the polyvinyl butyral polymer content of polyvinyl acetate is 1-4 %, the content of polyvinyl alcohol is 11-21%, and the content of acetal is 75-88%.

In some embodiments, the non-ion-conducting layers of the release liner free, laminatable multilayer polymer may comprise a polyurethane polymer.

In some embodiments, the initial ion-conducting layer of the release liner free, laminatable multilayer polymer may comprise a polyurethane polymer.

In some embodiments, the lithium salt of the release liner free, laminatable multilayer polymer is selected from lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato)borate and lithium difluoro(oxalato)borate.

In some embodiments, the plasticizer component of the release liner free, laminatable multilayer polymer is selected from at least one of propylene carbonate, ethylene carbonate, tetraglyme, triethylene glycol bis(2-ethylhexanoate), dimethyl glutarate, dimethyl 2-methylglutarate, bis(2-butoxyethyl) adipate, dimethyl adipate, diethyl carbonate, sulfolane, tetraglyme, γ-butyrolactone, triethylene glycol bis(2-ethylhexanoate), diethylene glycol butyl ether, diethylene glycol dibutyl ether, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone), and combinations thereof.

In some embodiments, the initial ion-conducting polymer layer of the release liner free, laminatable multilayer polymer has a thickness of about 10 μm to about 300 μm, preferably about 50 μm to about 100 μm. In some embodiments, the non-ion-conducting polymer layers of the release liner free, laminatable multilayer polymer each have a thickness of about 25 μm to about 350 μm, preferably about 25 μm to about 50 μm. In some embodiments, the non-ion-conducting layers of the release liner free, laminatable multilayer polymer of the release liner free, laminatable multilayer polymer stack are of approximately equivalent thickness. In some embodiments, the non-ion-conducting layers of the release liner free, laminatable multilayer polymer stack are of inequivalent thickness.

In some embodiments, one or more of the initial polymer layers of the release liner free, laminatable multilayer polymer are textured on at least one side.

In some embodiments, one or more of the initial layers of the release liner free, laminatable multilayer polymer are tinted in colour, wherein pigments or dyes may be added to any of the layers in order to impart colour or to colour balance.

In some embodiments, one or more of the initial layers of the release liner free, laminatable multilayer polymer stack is engineered to impart sound dampening properties.

In some embodiments, one or more of the polymer layers of the release liner free, laminatable multilayer polymer stack may further comprise additives selected from at least one of fillers, ultraviolet stabilizers, heat stabilizer, adhesion improvers, antioxidants, radical scavengers, cross linkers, or ultraviolet light absorbers.

Another aspect of the invention described herein provides an electrochemical device which may comprise a multilayer polymer film located between a first electrically conductive substrate containing and an anodic material and a second electrically conductive substrate containing and a cathodic material. In some embodiments, the multilayer polymer film of the electrochemical device may comprise a first non-ion-conducting polymer layer, an ion-conducting polymer layer, a second non-ion-conducting polymer layer. Said ion-conducting polymer layer may be sandwiched between said first and second non-ion-conducting polymer layers. upon processing, the entire release liner free, laminatable multilayer polymer stack transitions to an ion-conducting polymer interlayer.

In some embodiments, the electrochemical device is a battery, sensor, electrochromic device, fuel cell, capacitor or supercapacitor, membrane reactor, or electrolyzer.

Another aspect of the invention described herein provides an electrochromic device which may comprise a multilayer polymer film located between a first transparent substrate coated with a conductive coating and an anodic electrochromic metal oxide film and a second transparent substrate coated with a conductive coating and a cathodic electrochromic metal oxide film. In some embodiments, the multilayer polymer film of the electrochemical device may comprise a first non-ion-conducting polymer layer, an ion-conducting polymer layer, a second non-ion-conducting polymer layer. Said ion-conducting polymer layer may be sandwiched between said first and second non-ion-conducting polymer layers. upon processing, the entire release liner free, laminatable multilayer polymer stack transitions to an ion-conducting polymer interlayer.

In some embodiments, the electrochemical device may further comprise coupling one or more busbars to the first and second conductive materials and applying an electric bias between the busbars to cause a movement of ions through the device

In some embodiments, an edge seal to protect the ion-conductive material from the environment is incorporated into the electrochemical device.

### BRIEF DESCRIPTION OF THE DRAWINGS

The specific arrangements shown in the Figures should not be viewed as limiting. It should be understood that the illustrated elements, including the shape, size and scale, are not drawn in actual proportion to each other.

Further features and advantages of the present disclosure will become apparent from the following detailed description, taken in combination with the appended drawings, in which:

FIG. 1 is a schematic depiction of a multilayer stack that may be processed to provide an ion-conducting interlayer according to an exemplary embodiment of the invention.

FIG. 2 depicts a method for processing a multilayer stack to provide an ion-conducting interlayer according to an exemplary embodiment of the invention.

FIG. 3 is a schematic depiction of a multilayer stack before processing and the resulting ion-conducting interlayer after processing according to an exemplary embodiment of the invention.

FIG. 4 is a schematic depiction of a prior art electrochromic device.

FIG. 5 depicts a method for fabricating an electrochromic device according to an exemplary embodiment of the invention.

FIG. 6 depicts an electrochromic device assembly before lamination and the resulting electrochromic device assembly after lamination according to an exemplary embodiment of the invention.

FIG. 7 is a graph showing the change in CIE Y transmittance for bleached and colored states over repeated cycles for an electrochromic devices prepared according to Example 1 described herein.

FIG. 8 is a graph showing the change in CIE Y transmittance for bleached and colored states over repeated cycles for an electrochromic devices prepared according to Example 2 described herein.

FIG. 9 is a graph showing the change in CIE Y transmittance for bleached and colored states over repeated cycles for an electrochromic devices prepared according to Example 3 described herein.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a release liner free, laminatable multilayer polymer material or stack (referred to herein as a “multilayer stack” or simply a “stack”) that is processable to form an ion-conducting interlayer. The multilayer stack may comprise an ion-conducing layer and one or more protective layers. In some embodiments, the one or more protective layers comprise first and second protective layers. In some embodiments, the ion-conducting layer is sandwiched between the first and second protective layers. In some embodiments, each protective layer comprises a non-ion-conducting polymer-based material. The one or more protective layers may protect and/or, prevent or reduce degradation of the ion-conducting layer during storage and/or transportation. In other words, the one or more protective layers may be employed to replace traditional release liners. However, unlike with release liners, the one or more protective layers may not be removed when employing the ion-conducting layer in an electrochemical device. Instead, the multilayer stack may be processed to form a suitable ion-conducting interlayer (e.g., to render the entire multilayer stack ion-conducting). The composition of the resultant ion-conducting interlayer may be substantially homogenous. In some embodiments, processing the multilayer stack to render the multilayer stack ion-conducting may comprise applying heat and/or pressure to the multilayer stack. For example, processing may include or incorporate one or more of lamination, autoclaving, hot pressing, and other methods known to those skilled in the art.

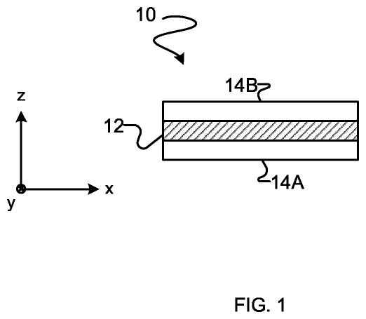

FIG. 1 is a schematic depiction of a release liner free, laminatable multilayer polymer material or stack 10 (referred to herein as “stack 10”) according to an example embodiment of the invention. Stack 10 comprises an ion-conducting layer 12 and one or more protective layers 14. The one or more protective layers 14 may comprise a first protective layer 14A and a second protective layer 14B. In some embodiments, ion-conducting layer 12 is sandwiched between first protective layer 14A and second protective layer 14B. It should be understood that the illustrated elements (e.g., io-conducting layer 12 and protective layer(s) 14), including the shape, size and scale thereof, are not drawn in actual proportion to each other but are provided merely for illustrative purposes.

Ion-conducting layer 12 may comprise any suitable ion-conducting polymer film. The ion-conducting polymer film may comprise a polymer base material and a plurality of conducting ions (e.g., as provided by a salt). In some embodiments, the ion-conducting polymer film may further comprise one or more plasticizers. In some embodiments, the ion-conducting polymer film may further comprise one or more solvents. In some embodiments, a solvent serves as the plasticizer and so an additional plasticizer may not be needed. In some embodiments, the initial ion-conducting polymer layer comprises between about 15 (wt %) to 45 (wt %) polymer base material, between about 45 (wt %) to 75 (wt %) plasticizer, and between about 10 (wt %) to 20 (wt %) salt (e.g., lithium salt).

In some embodiments, the polymer base material of ion-conducting layer 12 comprises a thermoplastic polymer base material. In some embodiments, the polymer base material of ion-conducting layer 12 comprises a thermoset polymer base material. The polymer base material of ion-conducting layer 12 may comprise a polymer resin. In some embodiments, the polymer resin comprises a polyvinyl butyral (PVB) resin. In some embodiments, the PVB polymer resin comprises a polyvinyl acetate content of about 1 (wt %) to about 4 (wt %), a polyvinyl alcohol content of about 11 (wt %) to about 21 (wt %), and an acetal content of about 75 (wt %) to about 88 (wt %). In some embodiments, the polymer base material of ion-conducting layer 12 comprises polyurethane, polyvinyl chloride, ethyl vinyl acetate based polymers (e.g., poly(ethylene vinyl acetate)) or combinations thereof.

In some embodiments, the conducting ions comprise lithium ions along with a suitable counter-ion. In some embodiments, the conducting ions comprise sodium or potassium ions. In some embodiments, the conducting ions are provided by a salt. In some embodiments, the salt comprises one or more lithium salts selected from one of lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato)borate and lithium difluoro(oxalato)borate. In some embodiments, the material of ion-conducting layer 12 comprises a salt in an amount sufficient to impart high ionic strength (e.g., a high concentration of ions) to the material.

In some embodiments, ion-conducting layer 12 exhibits ion-conductivity of at least 1×10⁻7 S/cm, of at least 1×10⁻⁶ S/cm, of at least 1×10⁻⁵ S/cm or even of at least 1×10⁻⁴ S/cm.

In some embodiments, the plasticizer is selected from at least one of propylene carbonate, ethylene carbonate, tetraglyme, triethylene glycol bis(2-ethylhexanoate), dimethyl glutarate, dimethyl 2-methylglutarate, bis(2-butoxyethyl) adipate, dimethyl adipate, diethyl carbonate, sulfolane, tetraglyme, y-butyrolactone, triethylene glycol bis(2-ethylhexanoate), diethylene glycol butyl ether, diethylene glycol dibutyl ether, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone), and combinations thereof.

In some embodiments, one or more additional additives may be incorporated into ion-conducting layer 12. Such additives may, for example, be employed to enhance performance or durability of the layer. Such additives may include, but are not limited to, fillers, ultraviolet stabilizers and/or ultraviolet light absorbers (such as, for example, benzotriazoles and benzophenones), heat stabilizers, adhesion improvers or promoters (such as, for example, silane-based compounds), antioxidants and/or radical scavengers (such as, for example, butylated hydroxytoluene), cross linkers, impact modifiers, ionic liquids (such as, for example, imidazolium and pyrrolidinium salts), moisture scavengers (such as, for example, molecular sieves like zeolites and desiccants such as calcium oxide or silica gel), pigments, dyes, infrared light absorbers or blockers, surfactants, chelating agents, and impact modifiers, in addition to other additives known to those skilled in the art.

In some embodiments, ion-conducting layer 12 has a Z-direction thickness of between approximately 10 um and 300 μm. In some embodiments, ion-conducting layer 12 has a Z-direction thickness of between approximately 50 μm and 100 μm.

The components of ion-conducting layer 12 (e.g., the polymer base material, the solvent, the conducting ions (e.g., as provided by a salt), the plasticizer and any additives) may be mixed using standard methods known to those skilled in the art, and includes, but not limited to mixers or kneaders.

Protective layer(s) 14 may act to protect ion-conducting layer 12 from reacting to, and/or being contaminated with, humidity, dust and other air contaminants during storage, transportation and/or handling. Protective layer(s) 14 may be non-ionically conductive or substantially non-ionically conductive. In some embodiments, protective layer(s) 14 exhibit ion-conductivity of less than 1×10⁻⁸ S/cm. In some embodiments, protective layer(s) 14 exhibit ion-conductivity of less than 1×10⁻⁹ S/cm.

Protective layer(s) 14 may comprise a polymer base material and one or more additives. In some embodiments, the polymer base material of protective layers 14 may be the same as the polymer base material of ion-conducting layer 12, but this is not mandatory. In some embodiments, first and second protective layers 14A, 14B may comprise the same polymer base material, but this is not mandatory. In some embodiments, first and second protective layers 14A, 14B comprise different polymer base materials.

In some embodiments, the polymer base material of one or both of protective layers 14 comprises a thermoplastic polymer base material. In some embodiments, the polymer base material of one or both of protective layers 14 comprises a thermoset polymer base material. The polymer base material of one or both of protective layers 14 may comprise a polymer resin. In some embodiments, protective layer(s) 14 comprise about 90-100% polymer resin. In some embodiments, the polymer resin comprises a polyvinyl butyral (PVB) resin. In some embodiments, the PVB polymer resin comprises a polyvinyl acetate content of about 1 (wt %) to about 4 (wt %), a polyvinyl alcohol content of about 11 (wt %) to about 21 (wt %), and an acetal content of about 75 (wt %) to about 88 (wt %). In some embodiments, the polymer base material of one or both of protective layers 14 comprises polyurethane, polyvinyl chloride, ethyl vinyl acetate based polymers (e.g., poly(ethylene vinyl acetate)) or combinations thereof.

In some embodiments, one or more additional additives may be incorporated into one or both protective layers 14. Such additives may include, but are not limited to, fillers, ultraviolet stabilizers and/or ultraviolet light absorbers (such as, for example, benzotriazoles and benzophenones), heat stabilizers, adhesion improvers or promoters (such as, for example, silane-based compounds), antioxidants and/or radical scavengers (such as, for example, butylated hydroxytoluene), cross linkers, impact modifiers, ionic liquids (such as, for example, imidazolium and pyrrolidinium salts), moisture scavengers (such as, for example, molecular sieves like zeolites and desiccants such as calcium oxide or silica gel), pigments, dyes, infrared light absorbers or blockers, surfactants, chelating agents, and impact modifiers, in addition to other additives known to those skilled in the art.

In some embodiments, ion-conducting layer 12 may not exhibit one or more desired characteristics such as, for example, sufficient adhesion with adjacent layers when incorporated into an electrochemical device, sufficient ultraviolet light stability, sufficient sound damping, sufficient mechanical properties (e.g., strength, toughness, rigidity, etc.), sufficient tint, etc. This may be especially true where ion-conducting layer 12 is pre-fabricated (e.g., by a third party) in bulk rather than for a specific application. In some embodiments, one or more properties of one or both of protective layers 14 may be configured such that the resultant ion-conducting interlayer 20 obtained by processing a stack 10 exhibits more desirable characteristics.

In some embodiments, one or both of protective layers 14 may provide improved adhesion (e.g., as compared to ion-conducting layer 12) with adjacent layers when stack 10 is incorporated into an electrochemical device. For example, a composition of protective layer(s) 14 may be chosen to improve adhesion to a glass substrate or a polymer substrate. In some embodiments, protective layer(s) 14 may include an adhesion promoter, such as, for example, a 3-aminopropyltriethoxysilane (APTES).

In some embodiments, one or both of protective layers 14 may provide improved ultraviolet light stability to stack 10 (e.g., as compared to ion-conducting layer 12 on its own). This may be achieved, for example, by increasing the concentration of UV stabilizers within protective layer(s) 14. Such UV stabilizers may include Hindered Amine Light Stabilizers (HALS) such as Tinuvin 770, which is chemically known as bis(2,2,6,6-tetramethyl-4-piperidinyl) sebacate. Such UV stabilizers may comprise between approximately 0.1% and 2% (by weight) or more of protective layer(s) 14. This increased ultraviolet stability of protective layer(s) 14 may serve to prevent or reduce degradation of ion-conducting layer 12 due to exposure to ultraviolet light.

In some embodiments, one or both of protective layers 14 may provide improved sound damping (e.g., as compared to ion-conducting layer 12 on its own). This may be achieved, for example, by varying the amount of cross-linking in the polymer base material of protective layer(s) 14 relative to the amount of cross-linking in the polymer base material of ion-conducting layer 12 to target damping of desired frequencies (e.g., more cross-linking for higher frequencies and less cross-linking for lower frequencies), by varying the density of protective layer(s) 14 relative to the density of the polymer base material of ion-conducting layer 12 to target damping of desired frequencies (e.g., higher density for higher frequencies and lower density for lower frequencies), and/or by varying the hardness of protective layer(s) 14 relative to the hardness of the polymer base material of ion-conducting layer 12 to target damping of desired frequencies (e.g., higher density for higher frequencies and lower density for lower frequencies). In this way, where ion-conducting layer 12 is well suited to damping of a particular frequency range, one or both of protective layers 14 may be configured (by varying one or more of the amount of crosslinking, the density and the hardness of that layer) to improve damping of one or more other frequency ranges such that stack 10 (and resultant ion-conducting interlayer 20) may provide damping across a broad spectrum of frequencies.

In some embodiments, mechanical properties of stack 10 may be dependent on the composition of one or both of protective layers 14. For example, increased strength, toughness and/or rigidity of stack 10 (e.g., as compared to ion-conducting layer 12 on its own) may be achieved, for example, by increasing/decreasing the amount of cross-linking in the polymer base material of protective layer(s) 14, by increasing the density of protective layer(s) 14, by changing the composition of the polymer base material (e.g. by varying ratios and compositions of constituent monomers) and/or by increasing the hardness of protective layer(s) 14.

In some embodiments, one or more pigments or dyes may be added to one or both of protective layers 14 to tint one or both of protective layers 14 (e.g., relative to the ion-conducting layer). Such pigments or dyes may be added to achieve a desired tint or colour of a resultant electrochromic device incorporating stack 10, to impart UV light protection and/or to impart infrared light reflectivity. For example, where the electrochromic device would otherwise have an undesirable natural yellow tint, a purple pigment may be added to one or both of protective layers 14 to balance the yellow tint such that a yellow tint of the resultant electrochromic device is reduced or prevented entirely. As another example, dye or pigment may be added to one or both of protective layers 14 to darken a resultant electrochromic device. In some embodiments, the pigment or dye comprises titanium dioxide, a metal oxide (e.g., zinc oxide), carbon black, organic molecules and/or a ceramic based pigment.

In some embodiments, each protective layer 14 has a Z-direction thickness of between approximately 25 μm to 350 μm. In some embodiments, each protective layer 14 has a Z-direction thickness of between approximately 25 μm to about 50 μm. In some embodiments, each protective layer 14 has an approximately same Z-direction thickness as ion-conducting layer 12, but this is not mandatory. In some embodiments, a Z-direction thickness of first protective layer 14A is approximately the same as a Z-direction thickness of second protective layer 14B, but this is not mandatory.

In some embodiments, one or more broad sides of first protective layer 14A and/or second protective layer 14B is textured (e.g., the surface has variances of between 5.0 μm and 1.0 mm in the Z-direction). Such texturing may be useful for later de-airing and/or gas release during manufacturing of an electrochemical device incorporating stack 10 (e.g., during a lamination step). Such texturing may be provided by any suitable technique, such as, for example, addition of an interlayer, textured rollers, etc.

The components of protective layer(s) 14 (e.g., the polymer base material and any additives) may be mixed using standard methods known to those skilled in the art, and includes, but not limited to mixers or kneaders.

In some embodiments, one or both of protective layers 14 comprise a prefabricated film.

The layers of stack 10 may be fabricated separately and then layered or may be fabricated together. For example, each of ion-conducting layer 12 and protective layer(s) 14 may be produced by any suitable process, including but not limited to, extrusion, co-extrusion, solution casting, solution coating, spin coating, spray coating, slot-die coating, painting, spreading, draw-down coating, compression molding, injection molding, melt extrusion, or other processes known to those of skill in the art.

In some embodiments, ion-conducting layer 12 is applied to first protective layer 14 by one of painting, spreading, casting, extrusion, a drawdown process, or other processes known to those of skill in the art, wherein the process can be repeated until an ion-conducting layer 12 of the desired Z-direction thickness is obtained. In some embodiments, each of ion-conducting layer 12 and protective layer(s) 14 are fabricated separately and then layered together by, for example, rolling.

In practice, protective layers 14 serve to protect ion-conducting layer 12 during storage, transportation and/or handling of stack 10. Then to allow stack 10 to be effective in an electrochemical device, stack 10 may be processed to form an ion-conducting interlayer having desired ionic-conductivity. In some embodiments, stack 10 may be processed to form an ion-conducting interlayer exhibiting ion-conductivity of greater than approximately 1×10⁻⁷ S/cm. In some embodiments, stack 10 may be processed to form an ion-conducting interlayer exhibiting ion-conductivity of greater than approximately 1×10⁻⁵ S/cm. In some embodiments, stack 10 may be processed to form an ion-conducting interlayer exhibiting ion-conductivity of greater than approximately 1×10⁻⁴ S/cm. In some embodiments, the ion-conducting interlayer may be substantially homogeneous.

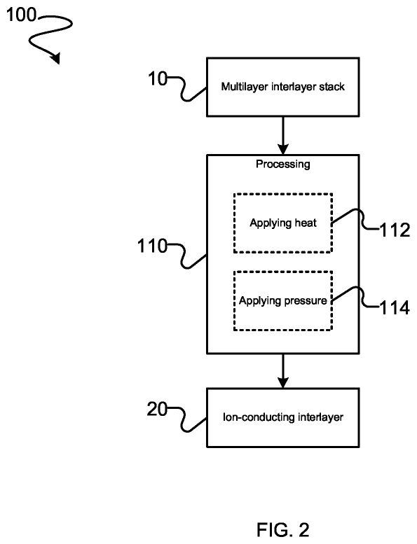

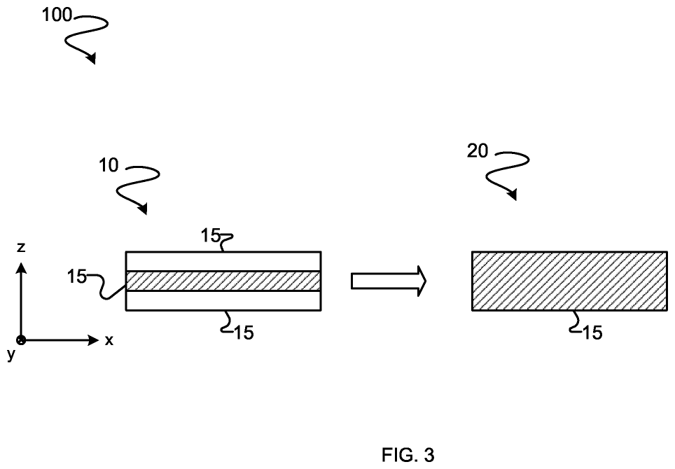

FIGS. 2 and 3 depict a method 100 of processing stack 10 to produce an ion-conducting interlayer 20 having desired ion-conducting properties.

Method 100 comprises a processing step 110. Processing 110 may comprise applying heat at sub-step 112 and/or applying pressure at sub-step 114 to achieve an ion-conducting interlayer 20. In some embodiments, sub-step 112 and sub-step 114 occur simultaneously but this is not required and they may occur in series (with either of sub-step 112 or sub-step 114 occurring first).

In some embodiments, applying heat at sub-step 112 comprises heating stack 10 to between approximately 80° C. and 100° C. In some embodiments, heat is applied at sub-step 112 for between approximately 5 minutes and 10 hours. Where lamination in an autoclave is employed at step 110, heat may be applied at sub-step 112 for between approximately 30 minutes and 5 hours. Where vacuum bagging is employed at step 110, heat may be applied at sub-step 112 for between approximately 2 hours and 10 hours.

In some embodiments, applying pressure at sub-step 114 comprises applying pressure to stack 10 at between approximately 0.5 bar and 15 bar. In some embodiments, pressure is applied at sub-step 114 for between approximately 5 minutes and 10 hours. Where lamination in an autoclave is employed at step 110, pressure of between approximately 6 bar and 15 bar may be applied at sub-step 114 for between approximately 30 minutes and 5 hours. Where vacuum bagging is employed at step 110, pressure of less than approximately 0.95 bar may be applied at sub-step 114 for between approximately 2 hours and 10 hours.

In some embodiments, processing block 110 may comprise applying heat and/or pressure by vacuum bag lamination, autoclave, hot press, etc.

In some embodiments, method 100 occurs prior to fabricating an electrochemical device such that an ion-conducting interlayer 20 fabricated by method 100 is incorporated into the electrochemical device directly. In other embodiments, method 100 occurs during fabrication of an electrochemical device such that stack 10 may be incorporated into the electrochemical device and method 100 may then occur during fabrication of the electrochemical device (e.g., in its own step or as part of an otherwise already occurring step such as lamination). In other words, fabrication of the electrochemical device may include applying sufficient heat and pressure (regardless of the incorporation of stack 10 rather than a traditional ion-conducting interlayer) to process stack 10 according to method 100 such that it is not necessary for method 100 to occur prior to fabricating of the electrochemical device.

Without being bound by theory, it is believed that during method 100, at least a portion of the conducting phase of ion-conducting layer 12 (e.g., the conducting ions and/or plasticizers) diffuses into the otherwise non-ion-conducting polymer of protective layer(s) 14 such that an entirety of the resultant ion-conducting layer 20 exhibits desirable ion-conducting characteristics.

In this way, not only can protective layer(s) 14 serve to protect ion-conducting layer 12 during storage, transportation and/or handling of stack 10 but stack 10 can then be processed to provide an ion-conducting interlayer 20 without removal of protective layer(s) 14. Incorporation of protective layer(s) 14 in stack 10 may thereby eliminate (or substantially reduce) a need to use release liners which in turn may eliminate the cost, complexity and/or waste associated with the use of traditional release liners. Further, incorporation of protective layer(s) 14 in stack 10 eliminates (or substantially reduces) a risk of damage to ion-conducting layers by removal of release liners since release liners are not employed and protective layer(s) 14 need not be removed when fabricating electrochemical devices incorporating stack 10 (or ion-conducting interlayer 20).

Another aspect of the invention provides a method for fabricating an electrochemical device incorporating the multilayer stack described herein (e.g. stack 10). The electrochemical device may comprise a battery (including a lithium ion battery or a sodium ion battery), sensor, fuel cell, membrane reactor, electrolyzer, capacitor or supercapacitor, or the like. The electrochemical device may comprise an electrochromic device such as an electrochromic window, electrochromic mirror, electrochromic sunroof, etc.

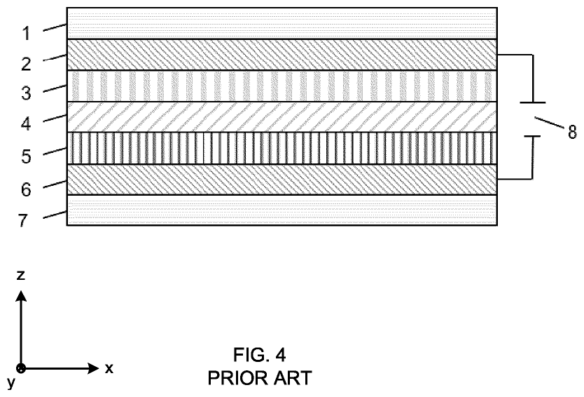

FIG. 4 schematically depicts a multilayer architecture of a prior art electrochromic device. FIG. 4 represents an electrochromic device that is connected to an external power source. The electrochromic device includes a first transparent substrate 1, a first transparent conductive layer 2, an anodic electrochromic layer or ion-storage layer 3, an ion-conductive polymer film electrolyte layer 4, a cathodic electrochromic layer 5, a second transparent electrically-conductive layer 6, and a second transparent substrate 7.

Substrates 1,7 provide a base structure for the active device materials and protection for the internal layers. The (transparent) electrically-conductive layers 2, 6 provide a means for conducting charge to and from the electrochromic layers 3, 5 from an external power source and/or control electronics and software 8. The conductive electrolyte layer 4 provides a means to transport ions between the anodic 3 and cathodic 5 electrochromic layers. For clarity, the thickness of the layers of the device, including the shape, size and scale of layers, is not drawn to scale or in actual proportion to each other, but is represented schematically.

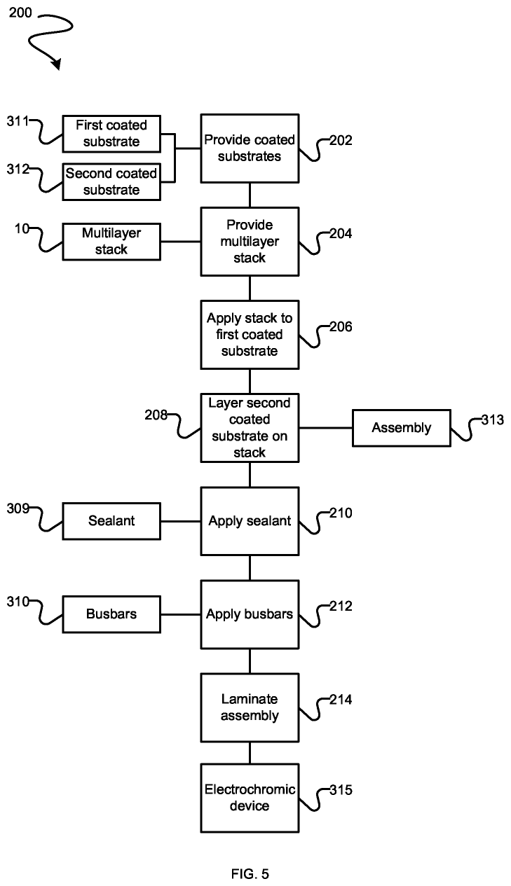

FIG. 5 depicts a method 200 for fabricating an electrochromic device 315 incorporating a release liner free, laminatable multilayer polymer material or stack as described herein (e.g. stack 10). For convenience, method 200 is described with reference to stack 10 but it should be understood that this is not necessary and method 200 could employ a different release liner free, laminatable multilayer polymer material or stack.

Electrochromic device 315 may comprise an electrochromic window, electrochromic mirror, electrochromic sunroof, etc.

Method 200 may comprise a step 202 of providing a first coated substrate 311 and a second coated substrate 312. First coated substrate 311 may comprise a first substrate 301 (e.g., a glass substrate), a first transparent conductive layer 302 and at least a first electrochromic layer 303 (e.g., an anodic electrochromic layer). Second coated substrate 312 may comprise a second substrate 307 (e.g., a glass substrate), a second transparent conductive layer 306 and at least a second electrochromic layer 305 (e.g., a cathodic electrochromic layer). The substrates 301, 307 provide a base structure for the active device materials and protection for the internal layers. The electrically-conductive layers 302, 306 provide a means for conducting charge to and from the electrochromic layers 303, 305 from an external power source and/or control electronics and software.

Substrates 301, 307 may comprise any suitable material known in the art, such as, for example, glass, polyethylene terephthalate (PET), polycarbonate, polyethylene naphthalate (PEN), polyvinyl butyral (PVB), polymethyl methacrylate (PMMA), acrylic, and polyvinyl chloride (PVC). For example, substrates 301, 307 may comprise a pane of glass or a sheet of polycarbonate.

First and second transparent conductive layers 302, 306 may comprise any suitable transparent conductive material such as, for example, indium tin oxide or fluorine-doped tin oxide.

First and second electrochromic layers 303, 305 may comprise transition metal oxides, transition metal complexes, conducting polymers, viologens, or the like. In other cases, organic dyes, such as viologens and phenazines may be used as the electrochromic moieties.

In some embodiments, one of first and second electrochromic layers 303, 305 may be replaced with an ion-storage layer. Common cathodic electrochromic materials include tungsten oxide (WOx), molybdenum oxide (“MoOx”), titanium oxide (TiOx), tantalum oxide (TaOx) and niobium oxide (NbOx) doped tungsten oxide. Known anodic electrochromic materials are nickel oxide (NiOx), doped nickel oxide, vanadium oxide (VOx), and iridium oxide (IrOx). Materials such as cobalt oxide (CoOx), manganese oxide (MnOx) and iron oxide (FeOx) have also been shown to exhibit electrochromic behaviour. First and second electrochromic layers 303, 305 are not necessarily a single material, but may comprise a mixture of the above materials. Suitable dopants may be included in the material composition of the first and second electrochromic layers 303, 305.

Method 200 may continue at step 204 with providing a release liner free, laminatable multilayer polymer material or stack. The release liner free, laminatable multilayer polymer material or stack may comprise, for example, multilayer stack 10.

Method 200 may continue at step 206 with applying or layering stack 10 on first coated substrate 311. Stack 10 may be arranged such that it is in contact with at least one electrochromic layer 303 of first coated substrate 311. Stack 10 may provide (e.g., after processing) a means to transport ions between anodic electrochromic layer 303 and cathodic electrochromic layer 305.

Method 200 may continue at step 208 with applying or layering second coated substrate 312 on stack 10 opposite first coated substrate 311. Stack 10 may be arranged such that stack 10 is in contact with at least one electrochromic layer 305 of second coated substrate 312 thereby sandwiching stack 10 to form a first assembly 313.

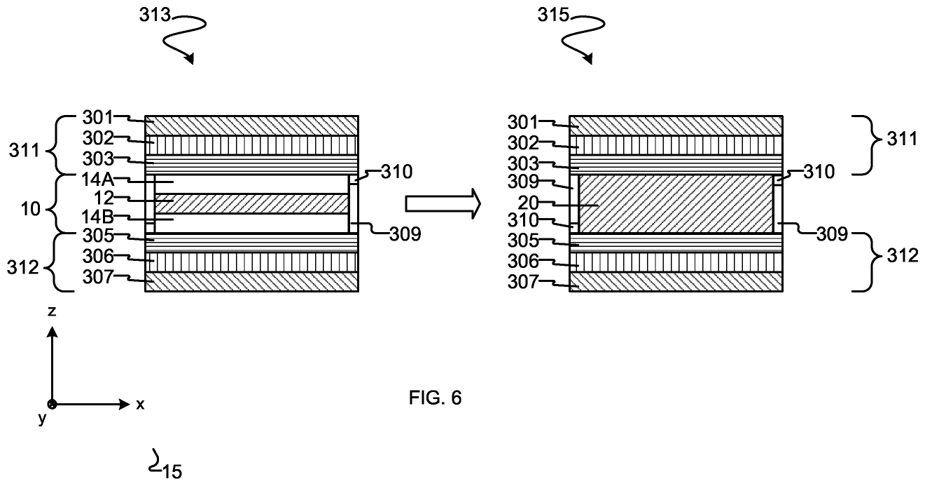

At step 210, a sealant material 309 may be applied around the perimeter of stack 10. Sealant material 309 may be arranged to be in contact with one or more of first conductive layer 302, first electrochromic layer 303, interlayer 304, second electrochromic layer 305 and second conductive layer 306, such as is shown schematically in FIG. 6. Any suitable edge sealant 309 can be applied as sealant 309 to avoid reaction of moisture, carbon dioxide and/or oxygen present in the atmosphere with the components of the electrochromic device, for example as described in U.S. Pat. No. 10,948,795. Sealing electrochromic device 315 may protect the conductive material from the outside environment.

At step 212, one or more busbars 310 may be applied to each electrode to facilitate electrical charge transfer to the electrically conductive substrate and/or a pigtail may be provided to allow connection of an electrical supply to the conductive glass substrates. Busbars 310 may be applied prior to the edge sealant 309, and can be encapsulated by sealant 309. In some embodiments, step 212 of coupling one or more busbars 310 to the first and second conductive materials includes applying an electric bias between busbars 310 to cause a movement of ions through electrochromic device 315. In a battery, this permits charging and discharging of the battery. In the case of an electrochromic window, the result is a change in transmission or reflectance of light through the device.

At step 214, a lamination process may be performed, comprising subjecting assembly 313 to pressure and heat. The pressure and/or heat may be sufficient to process stack 10 according to method 100. In other words, lamination at step 210 may effectively comprise step 110 of method 100. As such, at step 214, stack 10 may be processed to form ion-conducting interlayer 20 which may serve as an ion-conducting interlayer of electrochromic device 315, as shown schematically in FIG. 6. The pressure and/or heat at step 214 may be sufficient to deair stack 10. The pressure and/or heat may be sufficient so that sealant 309 and stack 10 adhere to first and second coated substrates 311, 312.

It is within the scope of the present invention that the order of the layers may be reversed with respect to the substrate. That is, the layers can be in the following order: first substrate, first transparent conductive layer, cathodic electrochromic layer, release liner free, laminatable multilayer polymer material or stack (e.g., stack 10), anodic electrochromic layer or ion-storage layer, second transparent conductive layer, and second substrate. It is also within the scope of the present invention that additional protective and functional layer(s) may also optionally be applied. The thickness of the layers of the device, including and the shape, size and scale of layers is not drawn to scale or in actual proportion to each other, but is represented for clarity.

Electrochromic devices 315 fabricated by method 200 may be used for a variety of applications, for example automotive mirrors, sunroofs, energy efficient glazing for buildings, and skylights, among others. Electrochromic device 315 may be incorporated into insulating glass units (IGUs).

While method 200 describes fabrication of an electrochromic device, it should be understood that other electrochemical devices could similarly incorporate release liner free, laminatable multilayer polymer material or stack (e.g. stack 10) in place of traditional ion-conducting interlayers without departing from the scope of the invention.

The invention will now be described with reference to specific examples. It will be understood that the following examples are intended to describe embodiments of the invention and are not intended to limit the invention in any way. It will be understood that certain aspects of the disclosed processes can be arranged and combined in a wide variety of different configurations, all of which are contemplated herein.

### EXAMPLES

### Example 1

In a first container, 0.75 g of polyvinyl butyral (PVB) resin (Mowital B 45 H, Kuraray) was added to a 2.5 g plasticizer blend of dimethyl adipate and dimethyl-2-methyl glutarate (Solvay). The solution was stirred mechanically until the PVB was fully dissolved in the plasticizer blend. In a second container, 0.75 g of lithium bis(trifluoromethylsulfonyl)imide (Gelon) was dissolved in 1 g propylene carbonate (Sigma). The two solutions were combined and stirred at ~35° C. until a clear viscous formulation was obtained. This gave 5 g of ion-conducting (electrolyte) material with PVB: Plasticizer: Li salt: percent ratio of 15:70:15. A portion of this material was applied to a four inch by four inch sheet of non-ion-conducting PVB material of thickness of about 0.16 mm. A second four inch by four inch piece of non-ion-conducting PVB material, of about 0.16 mm in thickness, was placed on top of the conducting PVB material to create a multilayer stack. The stack was pressed to ensure even thickness. This step also worked to remove any trapped air bubbles from the multilayer stack.

The multilayer stack was incorporated into an electrochromic device. The multilayer stack was placed onto a four inch by four inch piece of fluorine-doped tin oxide (FTO) coated glass (TEC 10; 10 Ω/sq) (Pilkington, Toledo, OH, USA) that previously been coated with an anodic or cathodic electrochromic oxide film. In this case, the substrate had been coated with tungsten oxide. One edge was masked during coating, so a section of blank FTO-coated glass substrate was present. A second four inch by four inch piece of fluorine-doped tin oxide (FTO) coated glass (TEC 10; 10 Ω/sq) (Pilkington, Toledo, OH, USA) that had previously been coated (except along one edge) with a complementary electrochromic oxide film, nickel oxide in this case, was placed on top of on the multilayer stack, and slightly offset on one edge from the bottom coated FTO piece. The pieces were arranged so that the electrochemical layers were in contact with the multilayer stack. The entire sandwich stack was then placed in an 80° C. to a 100° C. hot press, for 10 minutes. The device was removed from the hotpress and cooled to room temperature. Once at room temperature, copper busbars were attached along the blank FTO-coated glass offset edges.

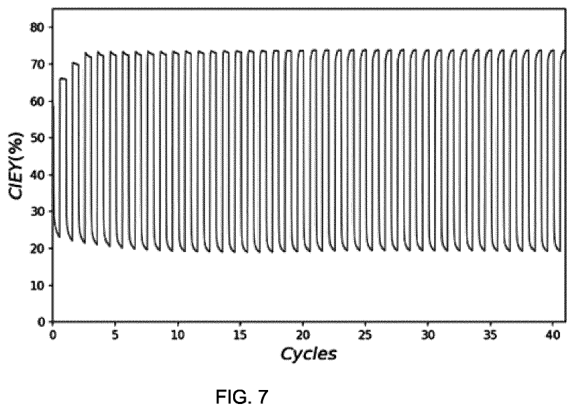

The resultant laminate device was cycled between its coloured and bleached states by applying alternating consecutive bias voltages (−1.5 V and +1.5 V) to the device at 180 second intervals. The change in transmittance at CIE Y scale for the electrochromic device as a function of time was recorded. The bleached state had a transmittance of 74% and the coloured state had a transmittance of 19%. FIG. 7 shows 40 switching cycles for the resultant laminate device.

### Example 2

In a first container, 0.75 g of polyvinyl butyral (PVB) resin (Mowital B 45 H, Kuraray) was added to a 2.5 g plasticizer blend of dimethyl adipate and dimethyl-2-methyl glutarate (Solvay). The solution was stirred mechanically until the PVB was fully dissolved in the plasticizer blend. In a second container, 0.75 g of lithium bis(trifluoromethylsulfonyl)imide (Gelon) was dissolved in 1 g propylene carbonate (Sigma). The two solutions were combined and stirred at ~35° C. until a clear viscous formulation was obtained. This gave 5 g of ion-conducting (electrolyte) material with PVB: Plasticizer: Li salt: percent ratio of 15:70:15. A portion of this material was applied to a four inch by four inch sheet of non-ion-conducting PVB material of thickness of about 0.32 mm. A second four inch by four inch piece of non-ion-conducting PVB material, of about 0.32 mm in thickness, was placed on top of the conducting PVB material to create a multilayer stack. The stack was pressed or rolled to ensure even thickness. This step also worked to remove any trapped air bubbles from the multilayer stack.

The multilayer stack was incorporated into an electrochromic device, whereby the multilayer stack was placed onto a four inch by four inch piece of fluorine-doped tin oxide (FTO) coated glass (TEC 10; 10 Ω/sq) (Pilkington, Toledo, OH, USA) that previously been coated with an anodic or cathodic electrochromic oxide film. In this case, the substrate had been coated with tungsten oxide. One edge was masked during coating, so a section of blank FTO-coated glass substrate was present. A second four inch by four inch piece of fluorine-doped tin oxide (FTO) coated glass (TEC 10; 10 Ω/sq) (Pilkington, Toledo, OH, USA) that had previously been coated (except along one edge) with a complementary electrochromic oxide film, nickel oxide in this case, was placed on top of on the multilayer stack, and slightly offset on one edge from the bottom coated FTO piece. The pieces were arranged so that the electrochemical layers were in contact with the multilayer stack. The entire sandwich stack was then placed in an 80° C. to a 100° C. hot press, for 15 minutes. The device was removed from the hotpress and cooled to room temperature. Once at room temperature, copper busbars were attached along the blank FTO-coated glass offset edges.

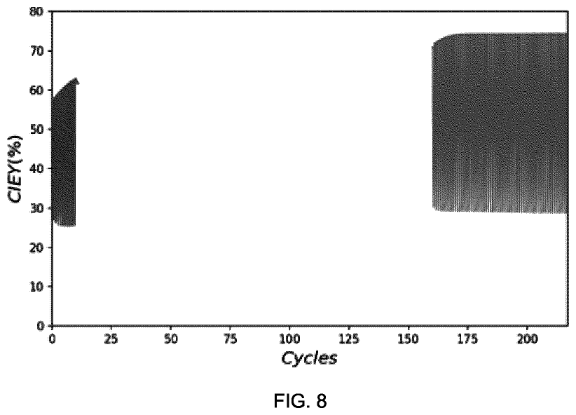

The resultant laminate device was cycled between its coloured and bleached states by applying alternating consecutive bias voltages (−1.5 V and +1.5 V) to the device at 180 second intervals. The change in transmittance at CIE Y scale for the electrochromic device as a function of time was recorded. The bleached state had a transmittance of 75% and the coloured state had a transmittance of 31%. FIG. 8 shows 220 switching cycles for the device, with transmittance data measured during cycles 1 to 10 and cycles to 160 to 220.

### Example 3

In a first container, 0.75 g of polyvinyl butyral (PVB) resin (Mowital B 45 H, Kuraray) was added to a 2.5 g plasticizer blend of dimethyl adipate and dimethyl-2-methyl glutarate (Solvay). The solution was stirred mechanically until the PVB was fully dissolved in the plasticizer blend. In a second container, 0.75 g of lithium bis(trifluoromethylsulfonyl)imide (Gelon) was dissolved in 1 g propylene carbonate (Sigma). The two solutions were combined and stirred at ~35° C. until a clear viscous formulation was obtained. This gave 5 g of ion-conducting (electrolyte) material with PVB:Plasticizer:Li salt:percent ratio of 15:70:15. A portion of this material was applied to a four inch by four inch sheet of non-ion-conducting PVB material of thickness of about 0.05 mm. A second four inch by four inch piece of non-ion-conducting PVB material, of about 0.05 mm in thickness, was placed on top of the conducting PVB material to create a multilayer stack. The stack was pressed or rolled to ensure even thickness. This step also worked to remove any trapped air bubbles from the multilayer stack.

The multilayer stack was incorporated into an electrochromic device, whereby the multilayer stack was placed onto a four inch by four inch piece of fluorine-doped tin oxide (FTO) coated glass (TEC 10; 10 Ω/sq) (Pilkington, Toledo, OH, USA) that had previously been coated with an anodic or cathodic electrochromic oxide film. In this case, the substrate had been coated with tungsten oxide. One edge was masked during coating, so a section of blank FTO-coated glass substrate was present. A second four inch by four inch piece of fluorine-doped tin oxide (FTO) coated glass (TEC 10; 10 Q/sq) (Pilkington, Toledo, OH, USA) that previously been coated with a complementary electrochromic oxide film, nickel oxide in this case, (except along one edge) was placed on top of on the multilayer stack, and slightly offset on one edge from the bottom coated FTO piece. The pieces were arranged so that the electrochemical layers were in contact with the multilayer stack. The entire sandwich stack was then placed in an 80° C. to a 100° C. hot press, for 10 minutes. The device was removed from the hotpress and cooled to room temperature. Once at room temperature, copper busbars were attached along the blank FTO-coated glass offset edges.

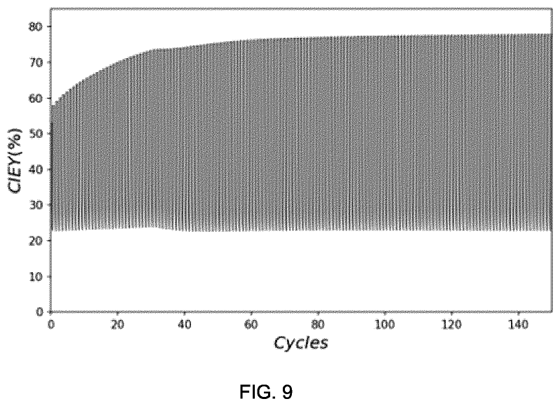

The laminate device was cycled between its coloured and bleached states by applying alternating consecutive bias voltages (−1.5 V and +1.5 V) to the device at 180 second intervals. The change in transmittance at CIE Y scale for the electrochromic device as a function of time was recorded. The bleached state had a transmittance of 79% and the coloured state had a transmittance of 23%. FIG. 9 shows 150 switching cycles for the device.

### Interpretation of Terms

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

Certain numerical values described herein are preceded by “about” or “approximately”. In this context, “about” or “approximately” provide literal support for the exact numerical value that it precedes, the exact numerical value ±5%, the exact numerical value ±10%, as well as all other numerical values that are near to or approximately equal to that numerical value. Unless otherwise indicated, a particular numerical value is included in “about” or “approximately” where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” or “approximately 10” also includes:
in some embodiments the numerical value is in the range of C to D where C and D are respectively lower and upper endpoints of the range that encompasses all of those values that provide a substantial equivalent to the value 10.

Unless the context requires otherwise, throughout this specification and claims, the words “comprise”, “comprising” and the like are to be construed in an open, inclusive sense. The words “a”, “an”, and the like are to be considered as meaning at least one and not limited to just one.

Unless defined otherwise, all technical and scientific terms used herein have the same meaning as commonly understood by one of ordinary skill in the art to which this invention belongs.

As used herein, the term “anodic electrochromic layer” may refer to a layer comprising a solid-state inorganic electrochromic material that transitions to its colored-state when ions are extracted. In the present application, it is located parallel to and positioned in between an electrically-conductive layer and a solid-state, ion-conductive electrolyte layer within an electrochromic device.

As used herein, the term “cathodic electrochromic layer” may refer to a layer comprising a solid-state inorganic electrochromic material that transitions to its colored-state when ions are inserted. In the present application, it is located parallel to and positioned in between an electrically-conductive layer and an ion-conducting layer within an electrochromic device.

As used herein, the term “cross linker” may refer to an additive which may link two entities by covalent or ionic bonds, which may alter the mechanical properties or viscosity of the material by reacting two different components.

As used herein, the term “cycled” may refer to the application of a bias voltage across the device by an external power source such as a battery or a potentiostat, and then, after a prescribed time, reversing the polarity. The reversed polarity may have a different voltage than the original bias voltage. The bias polarity is again reversed and a ‘cycle’ is complete.

As used herein, the term “electrochromic device” may refer to an electrochemical device comprising a substrate, an anodic electrode, a cathodic electrode, an ion-conductive layer, and charge-balancing ions, and which device is capable of transitioning transparency from a colored state (i.e., low transmittance of light through the window) to a transparent state (i.e., high transmittance of light through the window), and/or from a transparent state to a colored state, through the use of an applied electrical bias. The “transparent” state may also be referred to as a “bleached” state.

As used herein, the term “electrode” may refer to a layered structure comprising of a substrate, an electrically-conductive layer and an electrochemically-active layer parallel and in intimate contact with each other.

As used herein, the term “interlayer” may refer to a layer (of material) placed between other layers.

As used herein, the term “ion-conducting” may refer to the ability of a material to shuttle ions between different sites. As an example, the ion-conducting material herein, is capable of shuttling lithium ions between the anode and cathode upon the introduction of an external electrical bias.

As used herein, the term “layer” may be used synonymously with the term ‘coating’ to thereby refer to the resulting film formed by application of a mixture to a surface.

As used herein, the term “polymer” may refer to any homopolymer, copolymer, bipolymer, terpolymer, tetrapolymer or mixture thereof.

While processes, steps or blocks are presented in a given order, alternative examples may perform routines having steps, or employ systems having blocks or steps, in a different order, and some processes or steps or blocks may be deleted, moved, added, subdivided, combined, and/or modified to provide alternative or sub-combinations. Each of these processes or steps or blocks may be implemented in a variety of different ways. Also, while processes or steps or blocks are at times shown as being performed in series, these processes or steps or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Various features are described herein as being present in “one embodiment” or in some “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A release liner free, laminatable multilayer polymer stack for incorporation into electrochemical devices, the multilayer stack comprising:
an ion-conducting layer; and
one or more substantially non-ion-conducting protective layers layered on the ion-conducting layer;
wherein upon processing, the one or more protective layers become ion-conducting such that the entire multi-layer stack is ion-conducting.

2. The release liner free, laminatable multilayer polymer stack according to claim 1 or any other claim herein wherein the one or more protective layers exhibit ion-conductivity of less than 1.0×10⁻⁸ S/cm.

3. The release liner free, laminatable multilayer polymer stack according to any one of claims 1 and 2 or any other claim herein wherein the one or more protective layers comprise a first protective layer and a second protective layer and the ion-conducting layer is sandwiched between the first protective layer and the second protective layer.

4. The release liner free, laminatable multilayer polymer stack according to any one of claims 1 to 3 or any other claim herein wherein upon processing, the one or more protective layers exhibit ion-conductivity of greater than 1.0×10⁻⁷ S/cm.

5. The release liner free, laminatable multilayer polymer stack according to claim 4 or any other claim herein wherein processing comprises the application of heat.

6. The release liner free, laminatable multilayer polymer stack according to any one of claims 4 and 5 or any other claim herein wherein processing comprises the application of pressure.

7. The release liner free, laminatable multilayer polymer stack according to claim 4 or any other claim herein wherein processing comprises the application of heat at a temperature of between approximately 80° C. and 100° C.

8. The release liner free, laminatable multilayer polymer stack according to any one of claims 1 to 7 or any other claim herein wherein the ion-conducting layer comprises a polymer base material, a plasticizer, a solvent and a salt.

9. The release liner free, laminatable multilayer polymer stack according to any one of claims 1 to 7 or any other claim herein wherein the ion-conducting layer comprises between approximately 15% and 45 (by weight) of a polymer base material, between approximately 45% and 75% (by weight) of a plasticizer and between approximately 10% and 20% (by weight) of a salt.

10. The release liner free, laminatable multilayer polymer stack according to any one of claims 8 and 9 or any other claim herein wherein the polymer base material comprises a thermoset polymer

11. The release liner free, laminatable multilayer polymer stack according to any one of claims 8 and 8 or any other claim herein wherein the polymer base material comprises a thermoplastic polymer

12. The release liner free, laminatable multilayer polymer stack according to any one of claims 8 and 9 or any other claim herein wherein the polymer base material comprises polyvinyl butyral (PVB).

13. The release liner free, laminatable multilayer polymer stack according to any one of claims 8 and 9 or any other claim herein wherein the polymer base material comprises one or more of polyurethane, polyvinyl chloride, and ethyl vinyl acetate based polymer.

14. The release liner free, laminatable multilayer polymer stack according to any one of claims 8 to 13 or any other claim herein wherein the salt comprises a lithium salt.

15. The release liner free, laminatable multilayer polymer stack according to any one of claims 8 to 13 or any other claim herein wherein the salt comprises one or more of lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato)borate and lithium difluoro(oxalato)borate.

16. The release liner free, laminatable multilayer polymer stack according to any one of claims 8 to 15 or any other claim herein wherein the plasticizer comprises one or more of propylene carbonate, ethylene carbonate, tetraglyme, triethylene glycol bis(2-ethylhexanoate), dimethyl glutarate, dimethyl 2-methylglutarate, bis(2-butoxyethyl) adipate, dimethyl adipate, diethyl carbonate, sulfolane, tetraglyme, γ-butyrolactone, triethylene glycol bis(2-ethylhexanoate), diethylene glycol butyl ether, diethylene glycol dibutyl ether, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone).

17. The release liner free, laminatable multilayer polymer stack according to any one of claims 8 to 16 or any other claim herein wherein the ion-conducting layer further comprises one or more additives selected from fillers, ultraviolet stabilizers, heat stabilizer, adhesion improvers, antioxidants, radical scavengers, cross linkers, impact modifiers, ultraviolet light absorbers, ionic liquids, pigments, dyes, infrared light absorbers or blockers, surfactants, chelating agents, and impact modifiers.

18. The release liner free, laminatable multilayer polymer stack according to any one of claims 1 to 17 or any other claim herein wherein a thickness of the ion-conducting layer is between approximately 10 μm and 300 μm.

19. The release liner free, laminatable multilayer polymer stack according to any one of claims 1 to 17 or any other claim herein wherein a thickness of the ion-conducting layer is between approximately 10 μm and 100 μm.

20. The release liner free, laminatable multilayer polymer stack according to any one of claims 1 to 19 or any other claim herein wherein each of the one or more protective layers comprises a protective layer polymer base material.

21. The release liner free, laminatable multilayer polymer stack according to claim 19 or any other claim herein wherein the protective layer polymer base material is different from a polymer base material of the ion-conducting layer.

22. The release liner free, laminatable multilayer polymer stack according to any one of claims 20 and 21 or any other claim herein wherein the protective layer polymer base material comprises a thermoset polymer.

23. The release liner free, laminatable multilayer polymer stack according to any one of claims 20 and 21 or any other claim herein wherein the protective layer polymer base material comprises a thermoplastic polymer.

24. The release liner free, laminatable multilayer polymer stack according to claim 22 or any other claim herein wherein the protective layer polymer base material comprises polyvinyl butyral (PVB).

25. The release liner free, laminatable multilayer polymer stack according to claim 22 or any other claim herein wherein the protective layer polymer base material comprises one or more of polyurethane, polyvinyl chloride, and ethyl vinyl acetate based polymer.

26. The release liner free, laminatable multilayer polymer stack according to any one of claims 20 to 25 or any other claim herein wherein each of the one or more protective layers comprises one or more protective layer additives selected from fillers, ultraviolet stabilizers, heat stabilizer, adhesion improvers, antioxidants, radical scavengers, cross linkers, impact modifiers, ultraviolet light absorbers, ionic liquids, pigments, dyes, infrared light absorbers or blockers, surfactants, chelating agents, and impact modifiers.

27. The release liner free, laminatable multilayer polymer stack according to any one of claims 1 to 26 or any other claim herein wherein a concentration of ultraviolet light stabilizer in the ion-conducting layer is less than an amount of ultraviolet light stabilizer in at least one of the one or more protective layers.

28. The release liner free, laminatable multilayer polymer stack according to any one of claims 1 to 27 or any other claim herein wherein a degree of cross-linking in the ion-conducting layer is different than a degree of cross-linking in at least one of the one or more protective layers.

29. The release liner free, laminatable multilayer polymer stack according to any one of claims 1 to 27 or any other claim herein wherein a density of the ion-conducting layer is different than a density of at least one of the one or more protective layers.

30. The release liner free, laminatable multilayer polymer stack according to any one of claims 1 to 27 or any other claim herein wherein a hardness of the ion-conducting layer is different than a hardness of at least one of the one or more protective layers.

31. The release liner free, laminatable multilayer polymer stack according to anyone of claims 1 to 30 or any other claim herein wherein at least one of the one or more protective layers comprises a pigment or dye such that the at least one of the one or more protective layers is tinted relative to the ion-conducting layer.

32. The release liner free, laminatable multilayer polymer stack according to any one of claims 1 to 31 or any other claim herein wherein a thickness of each of the one or more protective layers is between approximately 25 μm and 350 μm.

33. The release liner free, laminatable multilayer polymer stack according to any one of claims 1 to 31 or any other claim herein wherein a thickness of each of the one or more protective layers is between approximately 25 μm and 50 μm.

34. The release liner free, laminatable multilayer polymer stack according to any one of claims 1 to 33 or any other claim herein wherein a thickness of a first protective layer of the one or more protective layers is different than a thickness of a second protective layer of the one or more protective layers.

35. The release liner free, laminatable multilayer polymer stack according to any one of claims 1 to 34 or any other claim herein wherein a broad surface of at least one of the one or more protective layers is textured.

36. The release liner free, laminatable multilayer polymer stack according to any one of claims 1 to 35 or any other claim herein wherein a broad surface of at least one of the one or more protective layers has a surface texture variance of between 5.0 μm and 1.0 mm.

37. An electrochemical device comprising a multilayer polymer film located between a first electrically conductive substrate containing an anodic material and a second electrically conductive substrate containing a cathodic material wherein the multilayer polymer film comprises the release liner free, laminatable multilayer polymer stack of any one of claims 1 to 36 or any other claim herein.

38. The electrochemical device of claim 37 or any other claim herein, wherein the device is a battery, sensor, electrochromic device, fuel cell, capacitor or supercapacitor, membrane reactor, or electrolyzer.

39. A method of fabricating an electrochemical device, the method comprising:
forming an assembly by layering a multilayer polymer film between a first electrically conductive substrate containing an anodic material and a second electrically conductive substrate containing a cathodic material; and
applying heat and pressure to laminate the assembly thereby making the entire multilayer polymer film ion-conducting;
wherein the multilayer polymer film comprises the release liner free, laminatable multilayer polymer stack of any one of claims 1 to 35 or any other claim herein.

40. The method according to claim 39 or any other claim herein, further comprising: coupling one or more busbars to the first and second conductive materials and applying an electric bias between the busbars to cause a movement of ions through the device

41. The method according to any one of claims 39 and 40 or any other claim herein, further comprising, applying an edge sealant to protect the ion-conductive material.

42. A release liner free, laminatable multilayer polymer stack for incorporation into electrochemical devices, the release liner free, laminatable multilayer polymer stack comprising:
a first non-ion-conducting polymer layer;
an ion-conducting polymer layer;
a second non-ion-conducting polymer layer;
wherein said ion-conducting polymer layer is sandwiched between said first and second non-ion-conducting polymer layers; and
wherein upon processing, the entire release liner free, laminatable multilayer polymer stack transitions to an ion-conducting polymer interlayer.

43. The release liner free, laminatable multilayer polymer stack of claim 42, wherein the processing step comprises a lamination process involving heat and optionally also pressure.

44. The release liner free, laminatable multilayer polymer stack of claim 42, wherein the initial ion-conducting polymer layer comprises about 15 (wt %) to about 45 (wt %) polymer resin, about 45 (wt %) to about 75 (wt %) plasticizer component, and about 10 (wt %) to about 20 (wt %) lithium salt.

45. The release liner free, laminatable multilayer polymer stack of claim 42, wherein the non-ion-conducting layers comprise about 90-100% polymer resin.

46. The release liner free, laminatable multilayer polymer stack of claim 42, wherein the same polymer resin is utilized in each layer in the release liner free, laminatable multilayer polymer stack.

47. The release liner free, laminatable multilayer polymer stack of claim 42, wherein the polymer resin utilized in the non-ion-conducting layers differs from the polymer resin utilized in the initial ion-conducting layer within the release liner free, laminatable multilayer polymer stack.

48. The release liner free, laminatable multilayer polymer stack of claim 42, wherein the polymer resin utilized in the non-ion-conducting layers of the release liner free, laminatable multilayer polymer stack differ in composition from each other.

49. The release liner free, laminatable multilayer polymer stack of claim 42, wherein the polymer layers are thermoplastics or thermosets.

50. The release liner free, laminatable multilayer polymer stack of claim 42, wherein the polymer layers comprise one or more of poly(vinyl butyral), polyurethane, poly(ethylene oxide), poly(ethylene vinyl acetate) and combinations thereof.

51. The release liner free, laminatable multilayer polymer stack of claim 42, wherein the non-ion-conducting layers comprises a polyvinyl butyral resin.

52. The release liner free, laminatable multilayer polymer stack of claim 42, wherein the initial ion-conducting layer comprises a polyvinyl butyral resin.

53. The release liner free, laminatable multilayer polymer stack according to any one of claims 51 and 52, wherein the polyvinyl butyral polymer content of polyvinyl acetate is 1-4 %, the content of polyvinyl alcohol is 11-21%, and the content of acetal is 75-88%.

54. The release liner free, laminatable multilayer polymer stack of claim 42, wherein the non-ion-conducting layers comprises a polyurethane polymer.

55. The release liner free, laminatable multilayer polymer stack of claim 42, wherein the initial ion-conducting layer comprises a polyurethane polymer.

56. The release liner free, laminatable multilayer polymer stack of claim 42, wherein the lithium salt is selected from lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato)borate and lithium difluoro(oxalato)borate.

57. The release liner free, laminatable multilayer polymer stack of claim 42, wherein the plasticizer component is selected from at least one of propylene carbonate, ethylene carbonate, tetraglyme, triethylene glycol bis(2-ethylhexanoate), dimethyl glutarate, dimethyl 2-methylglutarate, bis(2-butoxyethyl) adipate, dimethyl adipate, diethyl carbonate, sulfolane, tetraglyme, γ-butyrolactone, triethylene glycol bis(2-ethylhexanoate), diethylene glycol butyl ether, diethylene glycol dibutyl ether, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone), and combinations thereof.

58. The release liner free, laminatable multilayer polymer stack of claim 42, wherein the initial ion-conducting polymer layer has a thickness of about 10 μm to about 300 μm, preferably about 50 μm to about 100 μm.

59. The release liner free, laminatable multilayer polymer stack of claim 42, wherein the non-ion-conducting polymer layers each have a thickness of about 25 μm to about 350 μm, preferably about 25 μm to about 50 μm.

60. The release liner free, laminatable multilayer polymer stack of claim 59, wherein the non-ion-conducting layers of the release liner free, laminatable multilayer polymer stack are of approximately equivalent thickness.

61. The release liner free, laminatable multilayer polymer stack of claim 60, wherein the non-ion-conducting layers of the release liner free, laminatable multilayer polymer stack are of inequivalent thickness.

62. The release liner free, laminatable multilayer polymer stack of claim 42, wherein one or more of the initial polymer layers is textured on at least one side.

63. The release liner free, laminatable multilayer polymer stack of claim 42, wherein one or more of the initial layers is tinted in colour, wherein pigments or dyes may be added to any of the layers in order to impart colour or to colour balance.

64. The release liner free, laminatable multilayer polymer stack of claim 42, wherein one or more of the initial layers is engineered to impart sound dampening properties 65. The release liner free, laminatable multilayer polymer stack of claim 42, wherein one or more of the polymer layers further comprise additives selected from at least one of fillers, ultraviolet stabilizers, heat stabilizer, adhesion improvers, antioxidants, radical scavengers, cross linkers, or ultraviolet light absorbers.

66. An electrochemical device comprising:
a multilayer polymer film located between a first electrically conductive substrate containing and an anodic material and a second electrically conductive substrate containing and a cathodic material; the multilayer polymer film comprising:
a first non-ion-conducting polymer layer;
an ion-conducting polymer layer;
a second non-ion-conducting polymer layer;
wherein said ion-conducting polymer layer is sandwiched between said first and second non-ion-conducting polymer layers; and
wherein upon processing, the entire release liner free, laminatable multilayer polymer stack transitions to an ion-conducting polymer interlayer.

67. The electrochemical device of claim 66, wherein the device is a battery, sensor, electrochromic device, fuel cell, capacitor or supercapacitor, membrane reactor, or electrolyzer.

68. An electrochromic device comprising:
A multilayer polymer film located between a first transparent substrate coated with a conductive coating and an anodic electrochromic metal oxide film and a second transparent substrate coated with a conductive coating and a cathodic electrochromic metal oxide film; the multilayer polymer film comprising:
a first non-ion-conducting polymer layer;
an ion-conducting polymer layer;
a second non-ion-conducting polymer layer;
wherein said ion-conducting polymer layer is sandwiched between said first and second non-ion-conducting polymer layers; and
wherein upon processing, the entire release liner free, laminatable multilayer polymer stack transitions to an ion-conducting polymer interlayer.

69. The device according to any one of claims 67 or 68, further comprising: coupling one or more busbars to the first and second conductive materials and applying an electric bias between the busbars to cause a movement of ions through the device

70. The device according to any one of claims 67 or 68, wherein an edge seal to protect the ion-conductive material from the environment is incorporated.

71. Methods comprising any features, combinations of features and/or sub-combinations of features described herein or inferable therefrom.

72. Apparatus comprising any features, combinations of features and/or sub-combinations of features described herein or inferable therefrom.

73. Kits comprising any features, combinations of features and/or sub-combinations of features described herein or inferable therefrom.
